(19) United States
(12) Patent Application Publication
(10) Pub. No.: US 2009/0096174 A1
(43) Pub. Date: Apr. 16, 2009

(54) BLADE OUTER AIR SEAL FOR A GAS TURBINE ENGINE

(75) Inventors: Brandon W. Spangler, Vernon, CT (US); Corneil S. Paauwe, Manchester, CT (US); Dominic J. Mongillo, West Hartford, CT (US)

Correspondence Address: CARLSON, GASKEY & OLDS/PRATT & WHITNEY, 400 WEST MAPLE ROAD, SUITE 350, BIRMINGHAM, MI, 48009, US

(73) Assignee: UNITED TECHNOLOGIES CORPORATION, Hartford, CT (US)

(21) Appl. No.: 11/679,958

(22) Filed: Feb. 28, 2007

(51) Int. Cl. F02C 7/28

(52) U.S. Cl. 277/345; 415/173.1

(57) ABSTRACT

An air seal assembly includes a featherseal engaged between adjacent turbine engine components to close a gap therebetween. The featherseal includes a first lateral tab and a second lateral tab which defines a tab space therebetween. The tab space locks the featherseal into the turbine engine component to prevent fore-aft movement thereof.

### BACKGROUND OF THE INVENTION

This invention was made with government support under Contract No.: N00019-02-C-3003 awarded by the Department of the Navy. The government therefore has certain rights in this invention.

The present invention relates to a gas turbine engine, and more particularly to a featherseal for turbine engine components such as vanes and blade outer air seals (BOAS).

Gas turbine engines generally include fan, compressor, combustor and turbine sections positioned along an axial centerline often referred to as the engine axis of rotation. The fan, compressor, and turbine sections each include a series of stator and rotor blade assemblies. An array of blades and an axially adjacent array of vanes are referred to as a stage.

Each stator assembly, which does not rotate (but may have variable pitch vanes), increase the efficiency of the engine by guiding core gas flow into or out of the rotor assemblies.

Each rotor blade assembly includes a plurality of blades extending outwardly from the circumference of a disk. Platforms extend laterally outward from each blade and collectively form an inner radial flowpath boundary for core gas passing through the rotor assembly.

An outer case, including a multiple of blade outer air seals (BOAS), provides the outer radial flow path boundary. A multiple of BOAS are typically provided to accommodate thermal and dynamic variation typical in a high pressure turbine (HPT) section of the gas turbine engine. The BOAS aligned with a particular rotor assembly is suspended in close proximity to the rotor blade tips to seal between the tips and the outer case. The sealing provided by the BOAS facilitates retention of gas flow between rotor blades where the gas can be worked (or have work extracted). A featherseal is captured circumferentially intermediate each BOAS to span the intervening gap and minimize fluid leakage due to relative excursions of each BOAS.

A radial tab at the aft end of each featherseal prevents the featherseal from being dislodged in the forward and aft directions during movement of each BOAS. The radial tab is sandwiched between the trailing edge of the BOAS and a low pressure turbine (LPT) brushseal. The radial tab is typically hardcoated to minimize wear from the brushseal. Although effective, the hardcoating operation is relatively expensive and forms a relative rough surface which may increase leakage from the flowpath. Without the hardcoating operation, the radial tab will wear relatively rapidly. Wear of the radial tab may result in movement of the featherseal, increase in flowpath leakage, and ultimately the necessity of disassembly, repair and replacement of a multiple of internal components.

Accordingly, it is desirable to provide an inexpensive featherseal which minimizes fluid leakage out of the flowpath.

### SUMMARY OF THE INVENTION

The featherseal according to the present invention includes a first lateral tab and a second lateral tab which defines a tab space therebetween. The tab space engages a post as the featherseal is slidably engaged into a first featherseal slot of each blade outer air seal (BOAS to close a gap therebetween and thereby minimize leakage). The first lateral tab and the second lateral tab lock the featherseal into the BOAS to prevent fore-aft movement thereof. A longitudinal side of the featherseal opposite the tabs engages a second featherseal slot of an adjacent BOAS to provide an efficient seal therebetween.

The tabs provide a locking feature which eliminates the heretofore necessary hardcoating and bending operations. Eliminating these operations decreases the manufacturing expense of the featherseal and also reduces leakage through provision of a more uniform non-hardcoated surface.

The present invention therefore provides an inexpensive featherseal which minimizes fluid leakage out of the flowpath.

### BRIEF DESCRIPTION OF THE DRAWINGS

The various features and advantages of this invention will become apparent to those skilled in the art from the following detailed description of the currently disclosed embodiment. The drawings that accompany the detailed description can be briefly described as follows:

FIG. 1 is a general sectional diagrammatic view of a gas turbine engine HPT section;

FIG. 2A is an expanded sectional view of a BOAS assembly in the HPT section of FIG. 1;

FIG. 2B is an expanded sectional view illustrating assembly of a BOAS to a BOAS support of the BOAS assembly;

FIG. 3 is an expanded view of a BOAS and featherseal;

FIG. 4 is a perspective view of a BOAS;

FIG. 5 is an exploded perspective view of adjacent BOAS prior to assembly; and

FIG. 6 is an assembled view of the adjacent BOAS of FIG. 5.

### DETAILED DESCRIPTION OF THE DISCLOSED EMBODIMENT

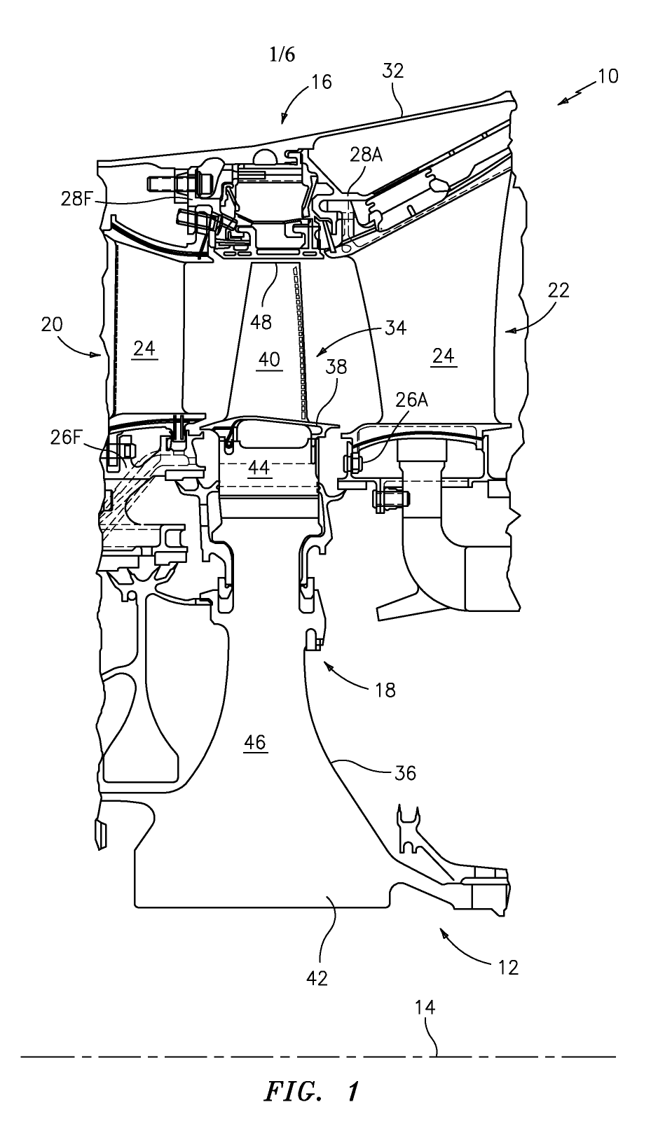

FIG. 1 schematically illustrates a gas turbine engine 10 (illustrated partially here as a High Pressure Turbine HPT section) having a turbine 12 disposed along a common engine longitudinal axis 14. The illustrated embodiment provides an air seal for high pressure turbine (HPT) blade outer air seal (BOAS) assemblies, also often known as turbine shroud assemblies. It should be understood that although a BOAS for a HPT is disclosed in the illustrated embodiment, the seal arrangement may be utilized in any section of a gas turbine engine. It should also be understood, however, that any type of air seals including seals between vane segments and the like may also benefit here from.

The air seal produced according to the present invention may find beneficial use in many industries including aerospace and industrial. The air seal may be beneficial in applications including electricity generation, naval propulsion, pumping sets for gas and oil transmission, aircraft propulsion, automobile engines, and stationary power plants.

The engine 10 includes a BOAS assembly 16 for sealing within the turbine 12. The turbine 12 includes a rotor assembly 18 disposed between forward 20 and aft 22 stationary vane assemblies. Each vane assembly 20, 22 includes a plurality of vanes 24 circumferentially disposed around an inner vane support 26. The vanes 24 of each assembly 20, 22 extend between the inner vane support 26F, 26A and an outer vane support 28F, 28A. The outer vane supports 28F, 28A are attached to an engine case 32.

The rotor assembly 18 includes a plurality of blades 34 circumferentially disposed around a disk 36, each blade 34 including a root 38 and an airfoil 40. The disk 36 includes a hub 42 and a rim 44, and a web 46 extending therebetween. The roots 38 are received within the rim 44 of the disk 36 and the airfoils 40 extend radially outward. The outer edge of each airfoil 40 may be referred to as the blade tip 48.

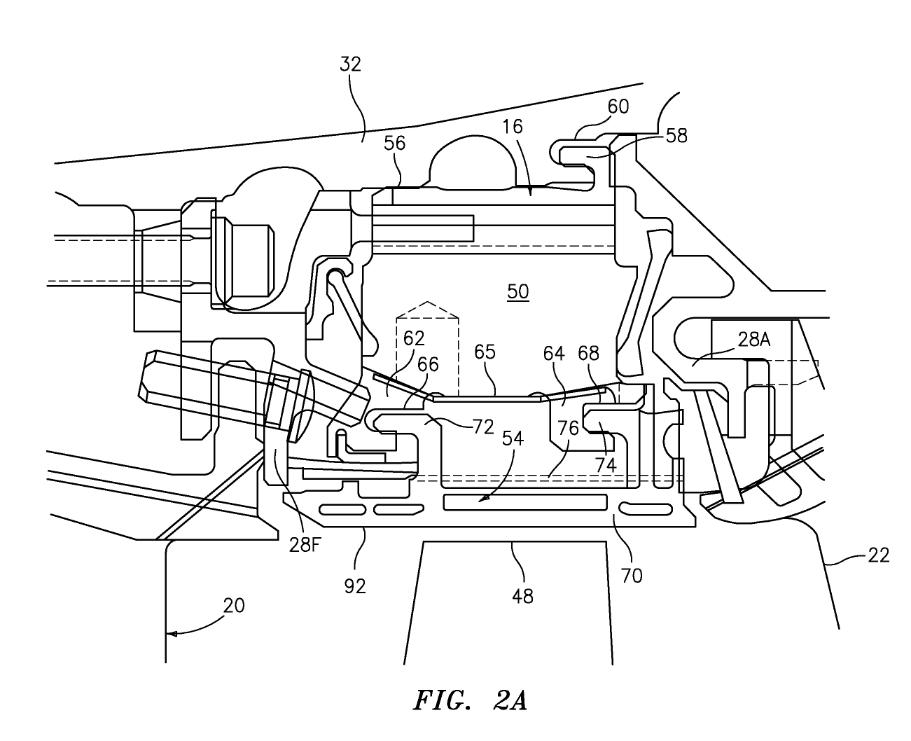

Referring to FIG. 2A, the BOAS assembly 16 is disposed in an annulus radially between the engine case 32 and the blade tips 48 of the rotor assembly 18, and axially between the forward 28F and aft 28A outer vane supports. Locating the BOAS assembly 16 between the forward 28F and aft 28A outer vane supports minimizes or eliminates loading on the BOAS assembly 16 from either vane assembly 20, 22. The BOAS assembly 16 includes a blade outer air seal (BOAS) support 50 and a multiple of blade outer air seals (BOAS) 54 mountable thereto (FIG. 2B). It should be understood that the BOAS support 50 may be a hoop or manufactured from individual segments. The BOAS support 50 is fixed within the engine case 32 by a press fit between an outer radial BOAS surface 56 and the engine case 32. A support attachment flange 58 further secures the BOAS support 50 with a receipt slot 60 within the engine case 32.

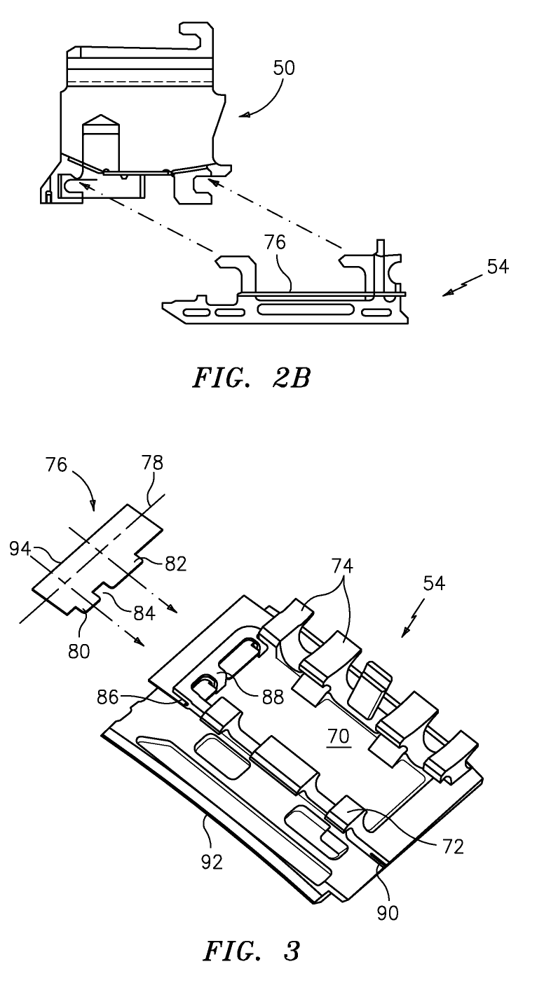

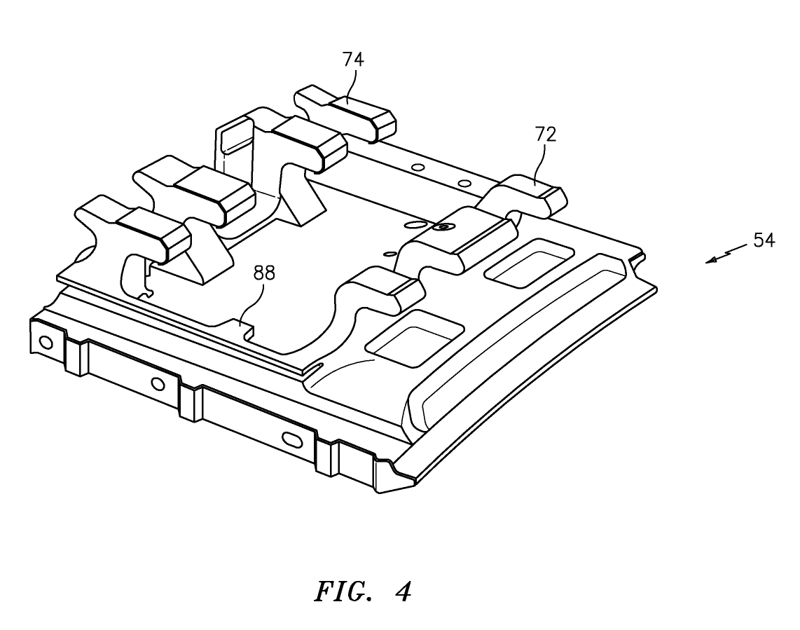

The BOAS support 50 includes a multiple of forward flanges 62 and aft flanges 64 which extend from an inner radial surface 65 thereof. The flanges 62, 64 are shaped such that they form a sideways “U” shaped slot 66, 68 with the opening thereof facing generally aft to receive the BOAS 54 in a generally upward and forward direction (FIG. 3).

The BOAS 54 includes a body 70 which defines a forward flange 72 and an aft flange 74. The forward flange 72 and the aft flange 74 respectively engage the slots 66, 68 in the BOAS support 50 (FIG. 3). The forward flange 72 and the aft flange 74 are assembled radially outward and forward to engage the slots 66, 68 and secure each individual BOAS 54 thereto. The forward 62 and aft 64 flanges are circumferentially segmented to receive the BOAS 54 in a circumferentially rotated locking arrangement as generally understood. A small intervening gap between each adjacent BOAS 54 facilitates thermal and dynamic relative movement. A featherseal 76 is engaged between each two adjacent BOAS 54 to close the gap and thereby minimize leakage therebetween to increase the engine operating efficiency.

Referring to FIG. 3, the featherseal 76 defines a longitudinal axis 78 which is generally parallel to the engine longitudinal axis 14 when installed. The featherseal 76 further includes a first lateral tab 80 and a second lateral tab 82 which defines a tab space 84 therebetween. That is, the first lateral tab 80 and the second lateral tab 82 extend transverse the longitudinal axis 78.

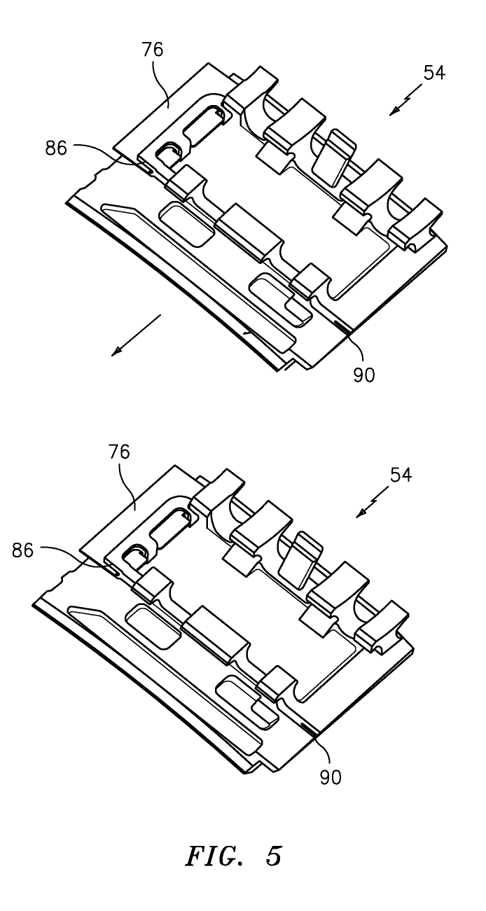

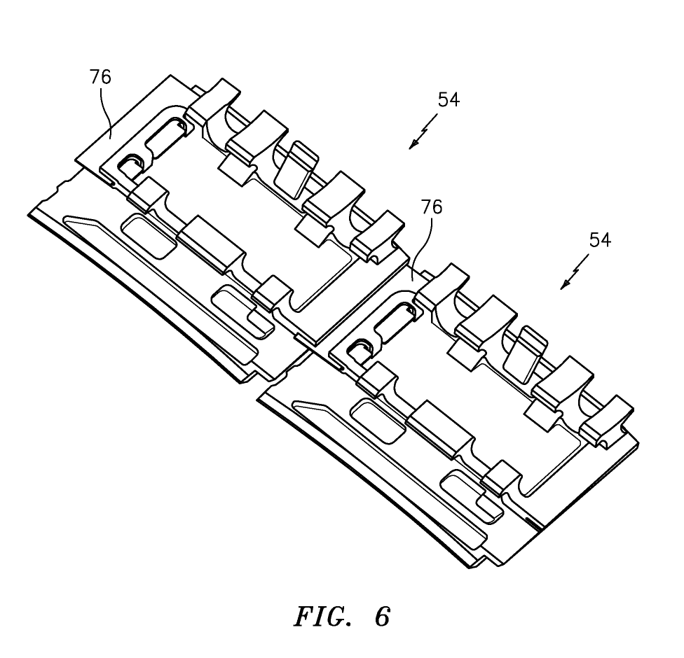

The featherseal 76 engages a first featherseal slot 86 defined by the BOAS body 70. The featherseal slot 86 further includes a post 88 transverse to a BOAS inner surface 92 (FIG. 2) adjacent the blade tips 48. It should be understood that the post 88 may be of any shape and results from machining of the featherseal slot 86 into the BOAS body 70. That is, the BOAS 54 shape facilitates formation of the post 88 which may be integral thereto. A second featherseal slot 90 is defined by the BOAS body 70 opposite the first featherseal slot 86. The second featherseal slot 90 need not include the post as a continuous longitudinal side 94 of the featherseal 76 is received therein. The tab space 84 engages the post 88 as the featherseal 76 is slidably engaged into the first featherseal slot 86. The first lateral tab 80 and the second lateral tab 82 lock the featherseal 76 into the BOAS 54 to prevent fore-aft movement thereof. The longitudinal side 94 of the featherseal 76 opposite the tabs 80, 82 engages the second featherseal slot 90 of an adjacent BOAS 54 (FIGS. 5 and 6) to provide an efficient seal therebetween.

The tabs 80, 82 provide a locking feature which eliminates the heretofore necessity of hardcoating the featherseal 76 and the radial tab. Eliminating the hardcoating process and the bending operation to form the radial tab decreases the manufacturing expense of the featherseal 76. Eliminating the hardcoating process also reduces leakage by permitting a more uniform surface to the featherseal 76 which provides a closer fit within the slots 86, 90. Furthermore, the brushseal now rides directly upon the BOAS 54 rather than the featherseal, providing a more continuous, consistent and wear reducing sealing interface to still further minimize leakage and maintenance requirements.

It should be understood that relative positional terms such as “forward,” “aft,” “upper,” “lower,” “above,” “below,” and the like are with reference to the normal operational attitude of the vehicle and should not be considered otherwise limiting.

It should be understood that although a particular component arrangement is disclosed in the illustrated embodiment, other arrangements will benefit from the instant invention.

The foregoing description is exemplary rather than defined by the limitations within. Many modifications and variations of the present invention are possible in light of the above teachings. The disclosed embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A featherseal for engagement with a turbine engine component comprising:
a featherseal which defines a longitudinal axis, said featherseal having a first lateral tab transverse to said longitudinal axis and a second lateral tab transverse to said longitudinal axis, said first lateral tab spaced from said second lateral tab.

2. The featherseal as recited in claim 1, wherein said featherseal is generally planar.

3. The featherseal as recited in claim 1, wherein said featherseal is non-hardened.

4. The featherseal as recited in claim 1, wherein said turbine engine component is a blade outer air seal.

5. A featherseal for engagement with a turbine engine component comprising:
a featherseal which defines a longitudinal axis, said featherseal having a tab space defined transverse to said longitudinal axis.

6. The featherseal as recited in claim 5, wherein said featherseal is generally planar.

7. The featherseal as recited in claim 5, wherein said featherseal is non-hardened.

8. The featherseal as recited in claim 5, wherein said tab space is defined between a first tab and a second tab.

9. The featherseal as recited in claim 5, wherein said turbine engine component is a blade outer air seal.

10. A blade outer air seal assembly comprising:
a first blade outer air seal defining a first featherseal slot and a second featherseal slot, said first featherseal slot including a post transverse thereto; and
a featherseal including a first lateral tab and a second lateral tab which defines a tab space therebetween, said featherseal engaged with said first featherseal slot such that said tab space is engaged with said post; and
a second blade outer air seal defining a first featherseal slot and a second featherseal slot, said first featherseal slot including a post transverse thereto, said featherseal engaged with said second featherseal slot.

11. The assembly as recited in claim 10, wherein said featherseal is generally planar.

12. The assembly as recited in claim 10, wherein said featherseal is non-hardened.

13. The assembly as recited in claim 10, wherein said featherseal defines a longitudinal axis, said featherseal having a first lateral tab transverse to said longitudinal axis and a second lateral tab transverse to said longitudinal axis, said first lateral tab spaced from said second lateral tab to define said tab space.

14. A turbine engine component comprising:
a first slot adjacent a first air seal edge and a second slot adjacent a second air seal edge laterally opposite said first air seal edge, at least one of said first and said second slots includes a post transverse thereto.

15. The turbine engine component as recited in claim 14 wherein said first and second laterally opposite edges are circumferentially opposite edges relative an engine axis.

16. The turbine engine component as recited in claim 14 wherein said post is configured to engage a tab space of a secondary seal.

17. The turbine engine component as recited in claim 14 wherein at least one of said first and said second slots include an opening adjacent said post to receive a tab of a secondary seal.

18. The turbine engine component as recited in claim 14 wherein said secondary seal is a featherseal.

19. The turbine engine component as recited in claim 14 wherein said outer air seal is a blade outer air seal.
